(19) United States
(12) Patent Application Publication
(10) Pub. No.: US 2018/0133929 A1
(43) Pub. Date: May 17, 2018

(54) ADAPTIVE GENERATION OF DRILLING PARAMETERS DURING AUTOMATED CORE DRILLING

(71) Applicant: Hilti Aktiengesellschaft, Schaan (LI)

(72) Inventors: Tobias DREXL, Weil (DE); Thomas SCHMALHOLZ, Kaufbeuren (DE); Andreas HARTIG, Augsburg (DE); Bernhard LINK, Schwabbruck (DE); Goran GOLUBOVIC, Buchloe (DE)

(21) Appl. No.: 15/570,190

(22) PCT Filed: Apr. 22, 2016
(86) PCT No.: PCT/EP2016/059012

§ 371 Date: Oct. 27, 2017

(30) Foreign Application Priority Data
Apr. 28, 2015 (EP) 15165311.0

(51) Int. Cl. B28D 7/00; B23B 49/00; B23B 51/04

(52) U.S. Cl. CPC B28D 7/005; B23B 49/00; B23B 51/0406; B23B 2226/75; B23B 2270/54; B23B 2270/32; B23B 2270/483; B23B 2270/486; B23B 2260/128

(57) ABSTRACT

A control method for the use of a core drilling system, including a core drill and a feed device for driving the core drill along a machine holding unit, including the method steps: detecting at least one first drilling parameter value during the core drilling operation; establishing the at least first drilling parameter value as a reference value; detecting at least one second drilling parameter value during the core drilling operation; comparing the at least second core drilling parameter with the reference value; and selecting a predetermined parameter setting for the core drilling system if the second drilling parameter exceeds or falls below the reference value by a predetermined corresponding threshold value. Also a feed device for driving a core drill along a machine holding unit for use of the method, a core drill for use of the method as well as a core drilling system including a core drill and a feed device for driving the core drill along a machine holding unit for use of the method.

The present invention relates to a control method for the use of a core drilling system, including a core drill and a feed device for driving the core drill along a machine holding unit.

The present invention also relates to a feed device for driving a core drill along a machine holding unit for the use of the method according to the present invention.

Furthermore, the present invention relates to a core drill for using the method according to the present invention.

In addition, the present invention relates to a core drilling system, including a core drill and a feed device for driving the core drill along a machine holding unit for the use of the method according to the present invention.

### BACKGROUND

The high torques and feed forces required during the core drilling of rock or other mineral materials are normally applied by the machine tool or core drill against a machine holding unit (so-called machine stand), which is fixedly connected to the substrate to be worked. The forces generated by the machine tool or the generated torque are transferred symmetrically to a guide rail via a movable guide carriage designed with a tool coupling part for centrally attaching the machine tool, and further via a bottom plate into the substrate to be worked. The forces required for advancing the machine tool are generated, in particular, by a feed device, which may be mechanically driven with the aid of a drive motor. This mechanical drive motor may, for example, be electrically, hydraulically or also pneumatically designed.

Such a device is known, for example, from EP 2 067 578, in particular, a transportable machine tool being disclosed, which is used as a drive for a core drill bit for drilling concrete and masonry.

The machine tool is fastened to a guide carriage with the aid of a machine coupling. In turn, the guide carriage is movable along a vertically or horizontally oriented machine stand, as a result of which the machine tool together with the core drill bit is also vertically movable. Due to the movability of the machine tool, the core drill bit driven by the machine tool is able to penetrate into the substrate being worked and to drill a hole.

When operating a core drill, the drilling parameters for the desired feed, i.e., the start position, the feed rate, the end position, the drilling depth, etc. are normally set manually via a terminal or a display on the feed device prior to the start of operation. Alternatively, the parameters for the desired feed may also originate from a signal which, in turn, may be generated from a power cable of the drill motor associated with the machine tool, which is looped from an energy source (for example, a socket outlet) via the feed device through to the drill.

In addition, the parameters of the core drill such as, for example, the rotational speed, the torque, the applied power, etc. are also manually input prior to the start of operation with the aid of a corresponding terminal on the core drill. The parameters are frequently selected with respect to the material to be worked, i.e., the substrate to be drilled.

A rock to be worked or a mineral material (for example, concrete, masonry or the like) is seldom completely homogenous in its composition. In other words: the consistency, density and other property values in the mineral material may vary significantly in places.

Because of these varying properties of the material to be worked, a core drilling operation also does not proceed absolutely uniformly and the drilling parameters of the core drilling system or of the individual components are subject to broad variations or changes. Thus, for example, the wall friction of a core drill bit increases with increasing drilling depth, which results in the reduction in the feed rate of the drill bit in the material to be worked. In core drilling systems according to the prior art, a drop in the drill feed rate, and in particular, if this drop falls below a predetermined proportional threshold value, is frequently equated with or interpreted as a collision of the core drill bit with a reinforcement bar (so-called iron strike). Many conventional core drilling systems or core drills have a setting mode in the event of an iron strike. The rotational speed of the core drill bit is correspondingly reduced with the aid of this setting mode and the torque generated by the core drill is increased, which enables a cutting of the reinforcement bar and a correspondingly rapid continuation of the drilling operation.

In addition to iron strikes, a sudden change in the material composition, in particular, with a change from concrete to an insulating material, screed material, asphalt material situated in the concrete or a particularly hard concrete layer may also result in an activation of the setting mode in the event of an iron strike.

Moreover, a sudden deterioration of the drill bit property, in particular, wear effects on the cutting elements of the drill bit, which may, for example, result in a reduction of the feed rate, may also result in an activation of the setting mode in the event of an iron strike.

The activation of the setting mode in the event of an iron strike results, however, in a significant reduction of the feed rate, so that the entire core drilling operation may be significantly prolonged. It is therefore desirable that in the event of an iron strike, the setting mode is really only selected for the core drilling system if the drill bit actually strikes a reinforcement bar in the mineral material (for example, concrete). If, however, merely the mineral material increases in consistency, hardness and density with increasing core drilling depth, a selection and activation of the setting mode in the event of an iron strike is not necessary and the core drilling system may be operated with a setting mode for a relatively soft mineral material (i.e., pure concrete).

### SUMMARY OF THE INVENTION

It is an object of the present invention to solve the above-described problems and, in particular, to provide a control method for the use of a core drilling system, with which a preferably rapid and efficient drilling operation may be achieved. In addition, the object of the present invention entails providing a feed device for driving a core drill along a machine holding unit, a core drill as well as a core drilling system, including a core drill and a feed device for driving a core drill along a machine holding unit using the method.

A control method is provided for the use of a core drilling system, including a core drill and a feed device for driving the core drill along a machine holding unit.

According to the present invention, the method includes the steps:
detecting at least one first drilling parameter value during the core drilling operation;
establishing the at least first drilling parameter value as a reference value;
detecting at least one second drilling parameter value during the core drilling operation;
comparing the at least second core drilling parameter with the reference value; and
selecting a predetermined parameter setting for the core drilling system if the second drilling parameter exceeds or falls below the reference value by a predetermined corresponding threshold value.

With this control method according to the present invention, the feed device according to the present invention as well as the core drill according to the present invention, it is possible to avoid the aforementioned disadvantages as well as to make the entire core drilling operation on the whole more efficient and shorter. With the present invention, it is possible, in particular, to efficiently adapt the core drilling operation to the varying composition of a material to be worked and to thereby optimize the core drilling operation.

According to one advantageous specific embodiment of the present invention, it may be useful for the detection of the at least first drilling parameter value as well as the establishment of the at least first drilling parameter value as a reference value to take place at predetermined intervals. In this way, the determination of the composition or consistency of the material to be worked may be carried out independently of the overall length or path of the core drilling operation.

According to another specific embodiment of the present invention, it may be advantageous if the detection of the at least one drilling parameter value as well as the establishment of the at least first drilling parameter value as a reference value takes place in predetermined sections of the path covered by the core drill along the machine holding unit during the core drilling operation. In this way, the determination of the composition or consistency of the material to be worked may be carried out independently of the feed rate of the core drilling tool during the core drilling operation.

To obtain a preferably informative description of the composition or consistency of the material to be worked, it may be possible according to one advantageous specific embodiment of the present invention for the first drilling parameter value and the second drilling parameter value to be a motor current intensity of a drive of the core drill, a torque generated by the core drill, a rotational speed value of the core drill, a rotational speed value of a drilling tool of the core drill or a feed rate value of the feed device along the machine holding unit.

A feed device is also provided for driving a core drill along a machine holding unit for the use of the method according to the present invention.

In addition, a core drill is provided for the use of the method according to the present invention.

Furthermore, a core drilling system, including a core drill and a feed device for driving the core drill along a machine holding unit is provided for the use of the method according to the present invention.

### BRIEF DESCRIPTION OF THE DRAWINGS

The present invention is explained in greater detail with reference to advantageous exemplary embodiments, in which

FIG. 1 shows a core drilling system according to the present invention, including a core drill, a feed device and a machine holding unit in a starting position;

FIG. 2 shows the core drilling system according to the present invention, including the core drill, the feed device and the machine holding unit at the start of a core drilling operation into a mineral material;

FIG. 3 shows the core drilling system according to the present invention, including the core drill, the feed device and the machine holding unit with a drill bit in the mineral material;

FIG. 4 shows the core drilling system according to the present invention, including the core drill, the feed device and the machine holding unit with a drill bit upon striking a reinforcement bar in the mineral material;

FIG. 5 shows the core drilling system according to the present invention, including the core drill, the feed device and the machine holding unit with a drill bit after cutting the reinforcement bar in the mineral material; and

FIG. 6 shows a flow chart of the control method according to the present invention.

### DETAILED DESCRIPTION

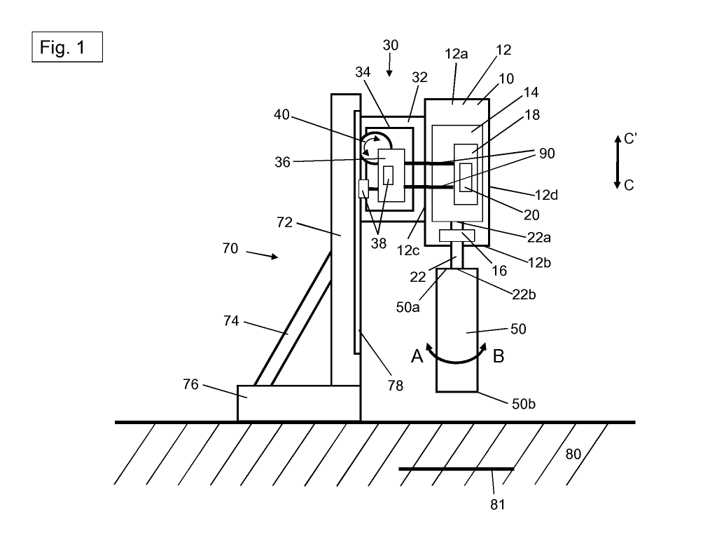

FIG. 1 shows a core drilling system 1 as a combination of a machine tool 10, a feed device 30, a drilling tool 50 in the form of a drill bit and a machine holding unit in the form of a machine stand 70.

Machine tool 10 is in the form of a core drill and includes a housing 12, a drive 14, a transmission 16, a first control unit 18, sensors 20 and a drive shaft 22. Drive 14 is in the form of an electric motor. Alternatively, any other type of drive may also be selected.

According to one specific embodiment of the present invention, drive 14 may be in the form of a high-frequency motor.

First control unit 18 is designed in such a way that all these parameters of machine tool 10 and, in particular, all parameters of drive 14 measured by sensors 20 of machine tool 10 are detected. These parameters include, for example, the engaged gear of transmission 16, the rotational speed of electric motor 14, the torque generated by electric motor 14, the rotational speed of drill tool 50, the applied and/or output power of electric motor 14, the applied current intensity of electric motor 14, etc.

Housing 12 includes a top side 12a, a bottom side 12b, a left side 12c and a right side 12d. Drive 14 is located in the interior of housing 12.

Drive shaft 22 has a first end 22a and a second end 22b. First end 22a of drive shaft 22 is connected to drive 14 in such a way that drive 14, designed as an electric motor, is able to set drive shaft 22 into a first rotational movement A or into a second rotational movement B. Second end 22b of drive shaft 22 projects from core drill 10 at bottom side 12b of housing 12. In addition, drill tool 50 in the form of a cylindrical drill bit includes a first end 50a and a second end 50b. First end 50a of drilling tool 50 is rotatably fixedly connected to second end 22b of drive shaft 22. Machine tool 10 is able to set drilling tool 50 into first rotational movement A or into second rotational movement B via drive shaft 22.

Feed device 30 includes a housing 32, in which a feed drive 34, a second control unit 36, sensors 38, as well as a drive pinion 40, are positioned. Second control unit 36 is designed in such a way that all these parameters of feed device 30 and, in particular, the parameters of feed drive 34 measured by sensors 38 of feed device 30, are detected. These measured parameters include, for example, the feed rate of feed device 30 relative to machine stand 70 or to work piece 80, the previously covered path of feed device 30 from the start of the drilling operation, measured from a starting point to be defined (also called zero point), the position of feed device 30 along machine stand 70, the rotation angle of feed drive 34, etc.

In addition, a plurality of parameters may be calculated by control unit 36 of feed device 30. The parameters in this case are calculated based on a comparison between the parameters detected by sensors 38 such as, for example, the rotation angle of drive pinion 40 and the predefined (i.e., pre-adjusted) parameters. Based on the parameter calculation, it is possible to ascertain, among other things, the feed rate of feed device 30 relative to machine stand 70, the relative and/or the absolute position of feed device 30, the path of feed device 30 previously covered since the start of the drilling operation, as well as the point in time and/or the path until the stop of drilling tool 50 is reached.

Feed drive 34 is, as shown in FIG. 1, designed in a first embodiment in the form of an electric motor.

Feed drive 34 drives drive pinion 40 under the control of control unit 36 and, therefore, feed device 30 relative to machine stand 70.

Feed device 30 is designed in such a way that the feed device may be mounted on machine stand 70 (as described below) and may be moved along machine stand 70 in arrow direction C with the aid of drive pinion 40. Sensors 38 are in the form of angle sensors, rotation angle sensors, acceleration sensors, speed sensors or position sensors and designed in such a way that these detect the acceleration, the feed rate, the angle, and the rotation angle as well as the position of feed device 30 either incrementally directly on feed drive 34 or absolutely along machine stand 70.

Machine stand 70 includes a guide rail 72, a strut element 74 as well as a base plate 76. Guide rail 72 is positioned on base plate 76 and supported by strut element 74 in such a way that guide rail 72 is aligned vertically or at the predefined angle. In addition, guide rail 72 includes a toothed bar 78 on one side. Strut element 74 in this case is optional and may also be omitted according to an alternative embodiment of the machine stand.

As also depicted in FIG. 1, housing 12 of machine tool 10 is fastened to housing 32 of feed device 30.

Feed device 30 is mounted on machine stand 70 in such a way that drive pinion 40 of feed device 30 engages in toothed bar 78 of machine stand 70. When drive pinion 40 is set into a rotational movement under the control of control unit 36 of feed drive 34, feed device 30 is reversibly moved along machine stand 70 in arrow direction C or C′. Because machine tool 10 is fastened to feed device 30, machine tool 10 is also moved along machine stand 70 in arrow direction C as a result of the movement of feed device 30 along machine stand 70 in arrow direction C. As a result of this vertical movement of machine tool 10, drilling tool 50 in the form of the cylindrical drill bit fastened to machine tool 10 is advanced vertically into workpiece 80 to be worked, i.e., into the substrate, thereby drilling a hole in workpiece 80. Material 80 in this case is in the form of mineral material, in particular, concrete including reinforcement bars 81.

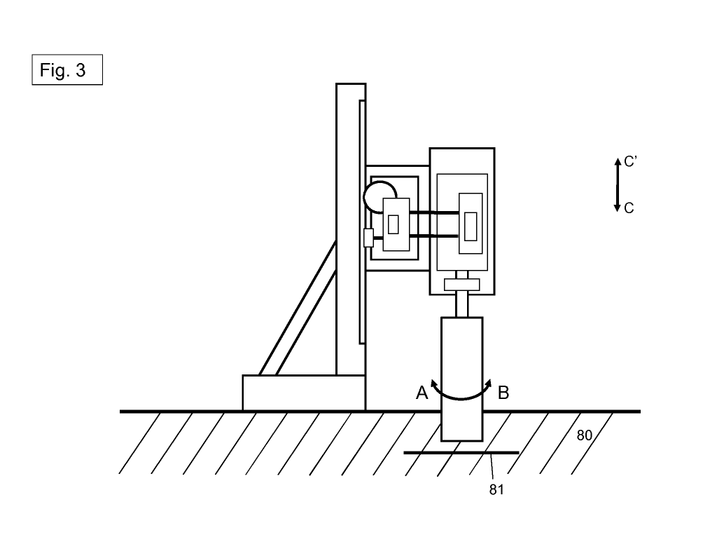

As previously described above, respective sensors 38 of feed device 30 measure the parameters of feed device 30. Respective sensors 38 of machine tool 10 also measure the parameters of machine tool 10. As depicted in FIG. 3, feed device 30 as well as machine tool 10 are connected to one another by connecting elements 90 in such a way that all detectable parameters of feed device 30 may be transmitted to machine tool 10 and all detectable parameters of machine tool 10 may be transmitted to feed device 30. Thus, a bi-directional communication exists between feed device 30 and machine tool 10. Due to this bi-directional communication, it is possible, among other things, for feed device 30 to be started and put into operation via a start switch not depicted on machine tool 10.

In addition, it is possible, in particular, for the information flow, i.e., the bi-directional transfer of the parameters between feed device 30 and machine tool 10 to take place with the aid of a power cable not shown. According to one advantageous embodiment, the bi-directional transfer of the parameters in this case may take place from power cable 100 via machine tool 10 to feed device 30.

### Drilling Operation:

The relevant parameters for feed device 30 and core drill 10 for the pending drilling operation are set prior to the drilling operation. These parameters such as, for example, feed rate, rotational speed of drive 14, rotational speed of drilling tool 50, drill bit diameter, etc., are frequently linked to material 80 to be worked and, in particular, with respect to the probably assumed degree of hardness of material 80.

In addition, these preset parameters (so-called setpoint parameters) are detected and stored in first and/or second control unit 18, 36. As such, it is possible for the setting of the relevant parameters for feed device 30 and core drill 10 to be effected solely based on the selected drill bit diameter. The parameters appropriate for the drill bit diameter such as, for example, rotational speed of drive 14, rotational speed of drilling tool 50, are stored in a software or in a data memory. The feed rate of feed device 30 and connected core drill 10 is set automatically or in a separate step as a function of the respectively selected power setting.

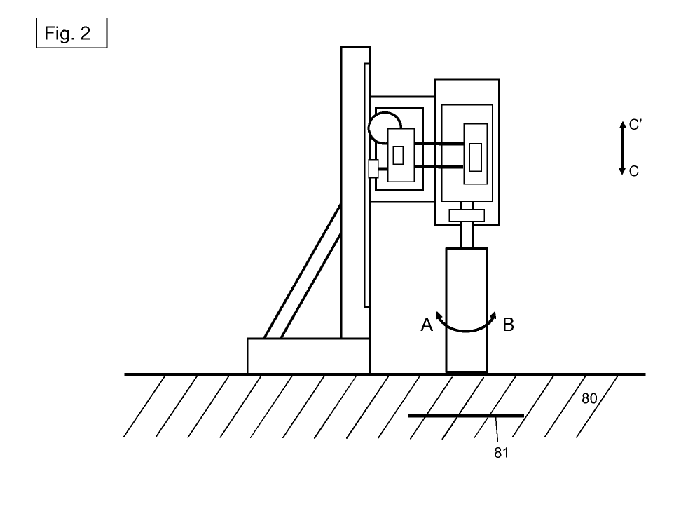

To carry out the actual core drilling operation, feed device 30 as well as core drill 10 are put into operation. Drilling tool 50, designed as a drill bit, rotates at a predefined rotational speed in rotation direction A or B. Feed device 30 moves core drill 10 with drill bit 50 in direction C toward material 80. Once second end 50b of drill bit 50 contacts the surface of material 80, the individual cutters cut into material 80 (cf. FIG. 2). Feed device 30 then moves core drill 10 with drill bit 50 further in direction C and deeper into material 80. In this way, a circular hole around a core is cut into material 80.

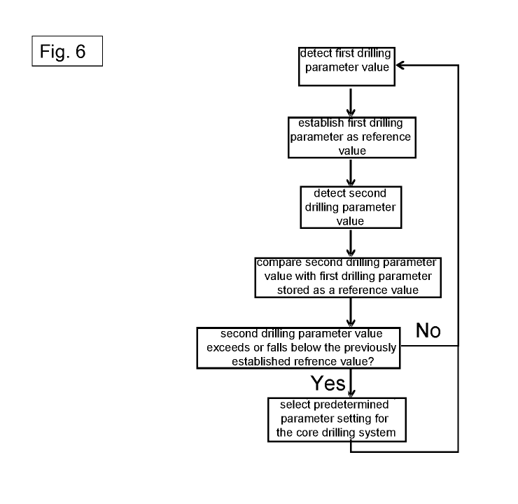

During the drilling operation, when drill bit 50 cuts into material 80 (cf. FIG. 3), a first drilling parameter value is detected at regular intervals with the aid of sensors 20, 38 according to a first step D1 of the control method according to the present invention (cf. FIG. 6). The regular intervals may be predetermined temporal intervals such as, for example, intervals of 10 seconds. It is also possible, however, for longer or shorter intervals to be determined. The intervals may also be predetermined sections of the path covered by the core drill along the machine holding unit during the core drilling operation. The intervals may be detected, for example, in 10 mm increments. It is also possible, however, for longer or shorter intervals to be determined.

The first core drilling parameter may be a motor current intensity of the electric motor of the core drill 10, a torque generated by core drill 10, a rotational speed value of core drill 10, a rotational speed value of a drilling tool 50 or a feed rate value of feed device 30 along machine holding unit 70.

According to a second step D2 of the control method according to the present invention, the first drilling parameter value is then established as a reference value. For this purpose, the value of the first drilling parameter is stored on first control unit 18 and/or on second control unit 36.

While the first drilling parameter value is being established as the reference value, the core drilling operation is continued.

According to a third step D3 of the control method according to the present invention, a second drilling parameter value is detected with the aid of sensors 20, 38. The second drilling parameter in this case corresponds in kind to the first drilling parameter value. In other words: if the first drilling parameter value is, for example, a first rotational speed value of core drill 10, then the second drilling parameter value is a second rotational speed of core drill 10. The first and second drilling parameter must be of the same kind so that the two drilling parameters (for example, rotational speed value of core drill 10) are correspondingly comparable to one another.

According to a fourth step D4 of the control method according to the present invention, the second drilling parameter value is compared with the first drilling parameter stored as a reference value. The comparison is made with the aid of first control unit 18 and/or of second control unit 36.

A threshold value with respect to each detected drilling parameter value is likewise stored or saved on first control unit 18 and/or on second control unit 36.

According to a fifth step D5 of the control method according to the present invention, it is decided whether the second drilling parameter value exceeds or falls below the previously established reference value corresponding to the actual kind of the drilling parameter. If the reference value is not exceeded or possibly falls below, fifth step D5 is then followed by first step D1.

If, during the core drilling operation, the second drilling parameter value exceeds the reference value by a predetermined threshold value, a predetermined parameter setting for the core drilling system is then selected according to a sixth step D6 of the control method according to the present invention. It may also be the case that the second drilling parameter value falls below the reference value by a specific threshold value during the core drilling operation. In this case as well, a predetermined parameter setting for the core drilling system is selected.

The predetermined parameter setting for the core drilling system in this case is selected as a function either of the exceedance or of the falling below of the respectively established reference value by a predetermined threshold value. The predetermined parameter setting for the core drilling system in this case is selected only if the established reference value for a first kind of drilling parameter value (for example, motor current intensity of the electric motor of core drill 10) is exceeded or if the established reference value for a second kind of drilling parameter value (for example, rotational speed value of drilling tool 50) is undercut.

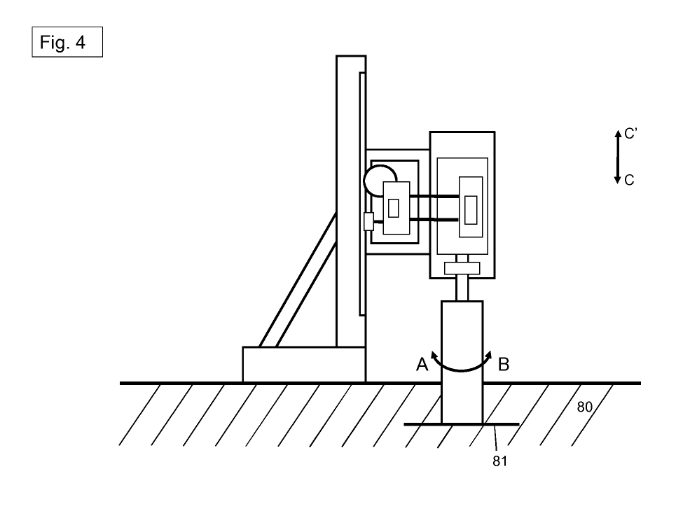

The selectable predetermined parameter setting for core drilling system 10 is, for example, a setting mode of core drilling system 10 in the event drill bit 50 strikes a very hard object, for example, a reinforcement bar 81, in material 80. Reinforcement bar 81 may also be referred to as reinforcing steel, concrete steel or reinforcing rod. Such a striking of the drill bit against a reinforcement bar 18 is referred to as “iron strike.” An iron strike by drill bit 50 during a core drilling operation is depicted in FIG. 4.

Since reinforcement bar 81 is normally produced from a material (for example, steel), which is significantly denser and harder compared to a mineral material (for example, concrete), several drilling parameter values of the core drilling system, of the feed device or of the core drill are in part abruptly changed when drill bit 50 strikes a reinforcement bar 81. Thus, at a constant power output of drive 14, for example, the feed rate of feed device 30 along machine stand 70 is higher when drill bit 50 cuts into mineral material 80 as compared to the feed rate of feed device 30 along machine stand 70 when drill bit 50 cuts through a steel reinforcement bar 81.

If the value of the feed rate of feed device 30 falls below the previously established reference value for the feed rate by a predetermined threshold value for the feed rate for a predetermined period of time (approximately 2 seconds), core drilling system 1 recognizes as a result that drill bit 50 is cutting a hard steel reinforcement bar 81 and an “iron strike” is present in mineral material 80.

Likewise, the torque generated by drive 14 and transferred to drill bit 50 is reduced if drill bit 50 strikes a steel reinforcement bar 81 in mineral material 80, since hard reinforcement bar 81 offers greater resistance to drill bit 50 than mineral material 80. If the torque falls below a predetermined torque threshold value for a predetermined period of time (for example, approximately 2 seconds), core drilling system 1 recognizes as a result that drill bit 50 is cutting a hard steel reinforcement bar 81 and an “iron strike” is present in mineral material 80.

The rotational speed value of drive 14 is also reduced if drill bit 50 strikes a steel reinforcement bar 81 in mineral material 80, since hard reinforcement bar 81 offers greater resistance to drill bit 50 than mineral material 80. If the rotational speed value of driver 14 falls below a predetermined rotational speed threshold value for a predetermined period of time (approximately 2 seconds), core drilling system 1 recognizes as a result that drill bit 50 is cutting a hard steel reinforcement bar 81 and an “iron strike” is present in mineral material 80.

In response to this, the corresponding predetermined parameter setting, i.e., the setting mode in the event of an iron strike is selected and set. In the setting mode in the event of an iron strike, the rotational speed of drill bit 50 is reduced and the torque generated by drive 14 and transferred to drill bit is correspondingly increased. In this way, reinforcement bar 81 may be more easily cut and the core drilling operation may be continued on the whole more rapidly and more efficiently.

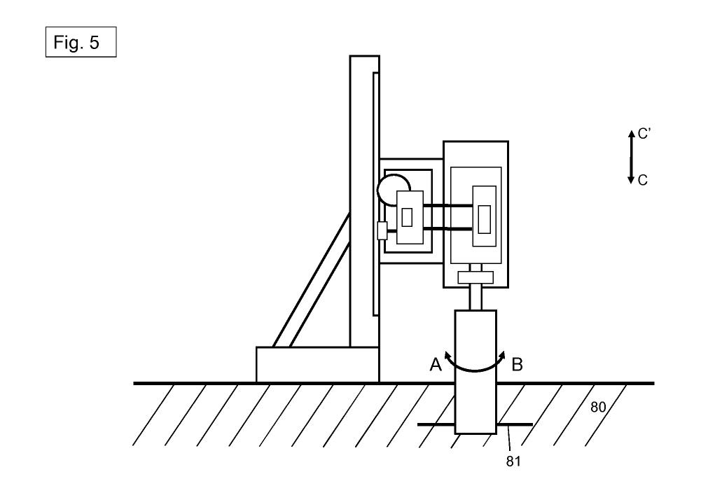

If, as depicted in FIG. 5, reinforcement bar 81 is cut and drill bit 50 again cuts mineral material 80, several drilling parameters again change. Thus, for example, at a constant power output of drive 14, the rotational speed value of drill bit 50 increases when cutting mineral material 80 as compared to the rotational speed value of drill bit 50 when cutting reinforcement bar 81.

If the low rotational speed value of drill bit 50 when cutting reinforcement bar 81 was established as a reference value for the first drilling parameter value and the second drilling parameter value is a higher rotational speed value of drill bit 50 when cutting mineral material 80, which exceeds a predetermined threshold value for the rotational speed of the drill bit, a predetermined parameter setting is then selected for the core drilling system, which is suitable for the cutting of a mineral material 80. For this purpose, for example, the torque generated by drive 14 and transferred to drill bit 50 is reduced accordingly.

Since mineral material 80 such as, for example, concrete, may become harder and denser with increasing depth in the direction C, and that above a certain degree of hardness it should be avoided that the core drilling system confuses mineral material 80 with reinforcement bars, as a result of which a setting mode in the event of an iron strike is automatically selected for the core drilling system, a first drilling parameter value is established routinely during the entire core drilling operation as a reference and is compared with a second drilling parameter value. In this way, the effect of a continuously increasing consistency, hardness and density in the mineral material to be worked may be counteracted and, as a result, mineral material and metallic material (for example, reinforcement bars) may be effectively differentiated. In this way, it is possible to carry out the entire core drilling operation more rapidly and more efficiently.

What is claimed is:

1 to 7 (canceled)

8. A control method for the use of a core drilling system, including a core drill and a feed device for driving the core drill along a machine holding unit, the method comprising the following steps:
detecting at least one first drilling parameter value during a core drilling operation;
establishing the at least first drilling parameter value as a reference value;
detecting at least one second drilling parameter value during the core drilling operation;
comparing the at least second core drilling parameter with the reference value; and
selecting a predetermined parameter setting for the core drilling system if the second drilling parameter exceeds or falls below the reference value by a predetermined corresponding threshold value.

9. The method as recited in claim 8 wherein the detecting of the at least one drilling parameter value as well as the establishing of the at least one first drilling parameter value as a reference value takes place in predetermined intervals.

10. The method as recited in claim 8 wherein the detecting of the at least first drilling parameter value as well as the establishing of the at least first drilling parameter value as a reference value takes place in predetermined sections of a path covered by the core drill along the machine holding unit during the core drilling operation.

11. The method as recited in claim 8 wherein the first drilling parameter value and the second drilling parameter value are a motor current intensity of a drive of the core drill, a torque generated by the core drill, a rotational speed value of the core drill, a rotational speed value of a drilling tool of the core drill or a feed rate value of the feed device along the machine holding unit.

12. A feed device for driving a core drill along a machine holding unit and for implementing the method as recited claim 8.

13. A core drill for implementing the method as recited in claim 8.

14. A core drilling system, comprising a core drill and a feed device for driving the core drill along a machine holding unit and implementing the method as recited in claim 8.
